(19) United States
(12) Patent Application Publication
(10) Pub. No.: US 2007/0240102 A1
(43) Pub. Date: Oct. 11, 2007

(54) Software development tool for sharing test and deployment assets

(75) Inventors: Stephen E. Bello, Austin, TX (US); Romelia H. Flores, Keller, TX (US); Mark R. Palmer, Coppell, TX (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 11/366,013

(22) Filed: Mar. 2, 2006

(51) Int. Cl. G06F 9/44

(52) U.S. Cl. 717/104

(57) ABSTRACT

A solution for sharing assets associated with componentized software units (software components) having a set of well defined interfaces. Each software component can be associated with a particular level of granularity and can be formed from one or more other lower-level software components. Each software components can be associated with one or more test assets as well as one or more deployment assets. The software components and associated assets can be stored in one or more shared asset repositories. Solutions and/or solution templates can be rapidly developed using automated tools associated with the shared asset repository, as previous design, test, and deployment efforts are able to be strongly leveraged.

### BACKGROUND

1. Field of the Invention

The present invention relates to the field of software development and, more particularly, to a software development tool for sharing test and deployment assets.

2. Description of the Related Art

Large software development projects typically segment a project into several manageable segments or software modules. Each software module includes an interface specification that details expected input, expected output, performance characteristics, and the like. Software modules are joined together to form a final software project. This described development methodology is nothing new, and software development tools exist to handle the modular development of an application.

The level of granularity for which conventional software development tools are designed is for an application level effort, where a single development entity integrates application modules. The development entity typically defines the functional modules within a software design model and defines interfaces between the modules necessary to form a working application. A software development functional test plan is created to test each module. The functional test plan also includes functional integration tests designed to test that the modules interoperate smoothly without parameter conflicts.

This functional testing represents only one type of necessary testing. Other types of testing include performance testing and user acceptance testing. Performance testing is designed to determine how efficiently a software application executes upon a target platform. Performance elements can be particularly important for an application that interoperates with users and/or other systems with real-time or near-real time performance constraints. For example, an audio and a video stream of a teleconferencing application must perform sufficiently that the communication stream presented to communicators appears smooth and has negligible delay. Performance testing can be difficult because a testing environment is often very different from an operational environment. Performance simulators exist that simulate an expected load within a virtual operating environment to determine how a system handles this load.

User acceptance testing is yet another type of testing, which is typically necessary before a software application is commercially deployed. Users often have a very different perspective on a software package than a software development team. Users focus on user interfaces, interoperability with other utilized applications, ease of use, and suitability for a user's purpose. Ideally, a software analysis effort conducted in an early stage of the software development life cycle will accurately determine user requirements and desires before design efforts begin. In practice, most software development efforts include a cyclic aspect, where prototypes are presented to users, feedback is received, and software is modified. In other words, user acceptance testing is part of an overall and iterative cycle of a software development effort, which continuously effects and changes the requirements for the software being developed.

Functional, performance, and user acceptance testing is often performed in parallel between a plurality of different test teams. Each of these test teams develop or utilize their own test strategy. As part of this strategy, many test artifacts or assets are developed. For example, a test team will typically define test objectives, testing scenarios, testing scripts/drivers, and testing documentation. These assets are rarely shared among teams involved in the same type of testing; functional, performance, or user acceptance. Performance and user acceptance test teams, in particularly, rarely share assets with other teams of the same type. Even more rarely, do standards or tools exist that permit assets to be shared between different types of test teams.

As a result, a total testing effort is often conducted in a haphazard and inefficient manner. Testing overlaps naturally occur and coverage gaps in tests often exist. Worse, problems initially identified within one type of testing, when testing is done in parallel, are not propagated quickly to other test teams. For example, if a user acceptance test indicates that a particular application feature is unacceptable or not unimportant, functional and development test teams will typically waste considerable effort testing the comparatively unimportant function. Similarly, user acceptance teams may critically test a desired feature and provide unfavorable feedback because of a functional flaw or performance flaw with that feature, which would have produced better user feedback if testers were aware that a problematic feature is not operating as intended, as determined by functional and performance test teams.

While the above problems may seem daunting enough, they represent only a part of an overall problem with conventional software development tools and practices. Software is integrated at many different granularity levels, but development tools are generally constructed for only one level. Different levels of granularity can include application level (or building block level) that joins many different modules into an application.

Another granularity of testing occurs at a suite level (or system level), which is designed to determine whether multiple applications join to create a coherent software system. For example, a word processing application, an email application, a spreadsheet application, and a contact management application can form an application suite that requires system level testing.

Still another granularity of testing is an enterprise level (or business or infrastructure solution testing) designed to test an end-to-end solution from a perspective of a target user. For example, different business systems can be joined as part of an enterprise solution for a business, such as a customer relationship management system, a business management system, and a customer interface system. Each of these systems requires functional testing, performance testing, and user acceptance testing.

Further, few solutions today are “pure” solutions that operate on only one granularity level or another. Development efforts are often distributively developed by different cooperating entities. Issues of complexity, time to market, integration of emerging technologies, disparate deployment platforms, and the like favor software componentization. That is, different software components are independently developed and rapidly deployed within a market. Each component is designed in a platform independent manner, and is intended to be interoperable with a myriad of other software components.

One example of this type of development at the application level includes plug-in and/or software objects, written in a platform independent language, such as JAVA, that can be integrated within any of a variety of browsers or applications. Another example of a distributed software development effort is the LINUX operating system and LINUX applications. In LINUX, open standards require code modules to be exposed to a software community. The software community develops derivates of popular software modules, the best of which are quickly embraced by the LINUX community. Different groups package these open source code units at different granularity levels, thereby defining different versions of a LINUX kernel, application suites (GNOME and KDE) and distribution packages (RED HAT, SUSE, DEBIAN, MANDRIVA, and the like).

Yet another example of a distributed software development approach relates to a service oriented architecture (SOA), where Web services can be developed, published in a centralized repository (UDDI directory), selected by users, and integrated with other Web services using open standards (WSL, SOAP, HTTP). This approach can provide an “abstraction” of generic business functions.

Currently, a need exists for a set of software development tools that permit different software test teams to share test artifacts. Additionally, there is a lack of tools for sharing deployment and integration assets needed to deploy a solution including multiple software components into a production environment. Conventional software development tools focus on only one particular granularity level and/or type of testing. Conventional software tools also focus upon only one type of technology, such as SOA, even though software solutions at different levels integrate software components based upon many different technologies.

What is needed is a new paradigm for software development that helps developers and testers to share assets of a distributed software environment. Preferably, this new software development tool will be robust enough to handle many different software technologies and flexible enough to permit different types of testers to benefit from assets created by other types of testers. Further, the new development tool should span different software granularity levels and permit a sharing of assets across these levels in a searchable fashion.

### SUMMARY OF THE INVENTION

A solution for sharing assets associated with componentized software units (software components) having a set of well defined interfaces. The software components can include Web services and other types of software objects. Software objects can include compiled code modules, interpreted code modules, and p-code modules. Each software component can be associated with a particular level of granularity and can be formed from one or more other lower-level software components. For instance, a system level software component can be formed from one or more block level software modules. Similarly, each block level software module can be used to build multiple system level software components.

Each software components can be associated with one or more test assets. Test assets can include testing objectives, testing scripts, testing drivers, testing data sets, testing results, and documentation. Additionally, each software object can be associated with one or more deployment assets for deploying the software component on a specified platform. Different platforms can be associated with different deployment assets.

The software components and associated assets can be stored in one or more shared asset repositories. If multiple repositories exist, the repositories can be configured to share information with each other. Each shared asset repository can include assets from multiple software projects. Multiple different development and test teams can access the data within the shared asset repositories. For example, a functional test team, a performance test team, and a user acceptance test team can each access test assets generated by other teams.

The general framework based upon storing and associating assets within the shared asset repository can encourage the sharing of best practices and can facilitate the utilization and acceptance of flexible standards. That is, the solution presented herein can provide a consistent and automated framework for sharing software components and associated assets. This can reduce duplication of effort and permit different teams to leverage the work products of other teams. The solution can also provide a means to coordinate and quickly disseminate results among one or more teams testing a software component from remote locations or in parallel with each other. For example, a functional testing team can immediately receive feedback generated by performance test teams and user acceptance test teams, which can change testing objectives and priorities of the functional testing team. Further, each of the various test teams can share common assets, such as test data, resulting in more rapid and consistent testing of software.

The present invention can be implemented in accordance with numerous aspects consistent with material presented herein. For example, one aspect of the present invention can include a method for sharing reusable software development assets. The method can componentize one or more software components. Each software component can have a set of well defined interfaces. The software components can be cataloged within different granularity levels. The granularity levels can include a building block level and a system level. At least a portion of the software components of the system level can be formed using software components of the building block level.

Test assets can be identified that are associated with the software components. The test assets can include assets for functional testing, user acceptance testing, and performance testing. The software components and the test assets can be stored in a searchable asset repository. The asset repository can be accessible by multiple test teams. The teams can include teams performing different types of testing. Functional test teams, user acceptance test teams, and performance test teams can access test assets of other teams.

Another aspect of the present invention can include a software development graphical user interface (GUI). The GUI can include a user configuration lab, a functional development view, and an integration testing view. The lab can include graphical objects representing software components. Each software component can be a componentized software unit having a set of well defined interfaces. Software components can also be categorized into various granularity levels, such as a building block level, a system level, and a solution level. Software components can be associated with multiple test assets. The functional development view of the lab can include graphical objects for functional test assets associated with the software components established for the lab. The integration testing view of the lab can be automatically generated at least in part using previously stored functional test assets and software components specified in the functional development view.

Still another aspect of the present invention can include a method used for developing software. In the method, assets can be stored within a shared asset repository. The assets can include software components and test assets associated with the software components. The assets can be categorized by granularity level. The stored software components can include foundation software components and composite software components. Composite software component are formed from one or more foundation software components having a granularity level one lower than the composite software component. Criteria can be identified for a new software component. At least one stored composite software component having similar criteria as the identified criteria can be determined by searching the shared asset repository. The composite software component can be categorized at the same level of granularity as the new software component.

A development interface can be utilized to construct the new software component from foundation software components associated with the composite software components. The new software component can be tested using at least one test asset previously stored within the shared asset repository. The test asset can be one that has been associated with a foundation software component upon which the new software component was constructed or one that has been associated with the determined composite software component.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for sharing software development assets in accordance with an embodiment of the inventive arrangements disclosed herein.

FIG. 2 includes two Venn diagrams that show a manner in which information of an asset repository can be shared in accordance with an embodiment of the inventive arrangements disclosed herein.

FIG. 3 is a schematic diagram illustrating the sharing of assets between multiple labs in accordance with an embodiment of the inventive arrangements disclosed herein.

FIG. 4 is a schematic diagram illustrating how the reusable assets in the shared repository can evolve with usage.

### DETAILED DESCRIPTION OF THE INVENTION

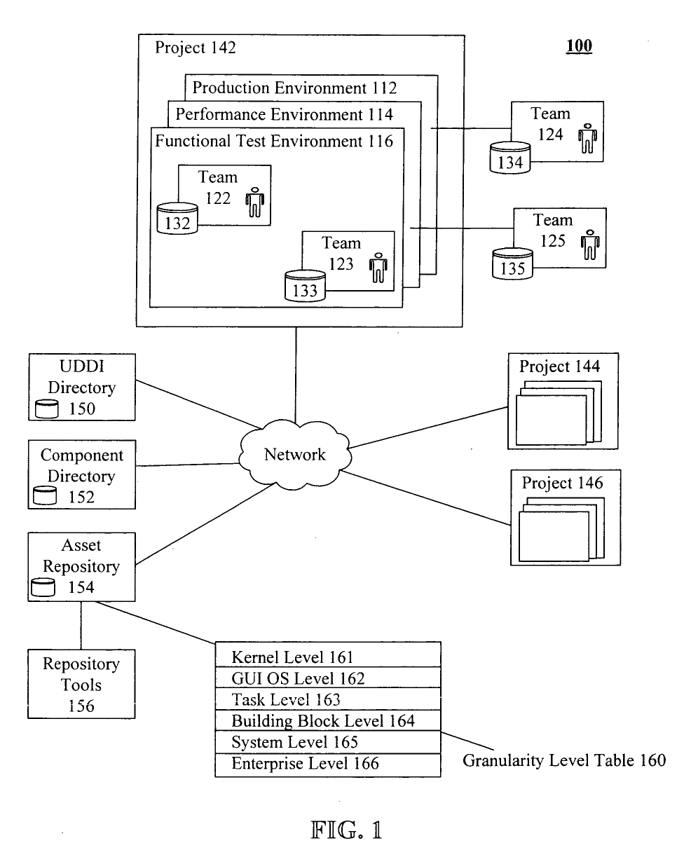

FIG. 1 is a schematic diagram of a system 100 for sharing software development assets in accordance with an embodiment of the inventive arrangements disclosed herein. In system 100, an asset repository 154 can be used to store and share software development assets, each relating to one or more software components. The asset repository 154 can also store and associate test, integration, and deployment assets to related ones of the software components.

The stored software components can include componentized software units having a set of well defined interfaces. That is, stored software components can include modularized units of coded instructions, each having internal operations abstracted from other software components and users of the software component. Hence the various ones of the software components can be considered “black boxes” or “veneers” which require a specified input to produce a specified output.

The componentization of software components permits software components to be treated in a uniform fashion, regardless of underlying implementation specifics. So long as requirements of the well defined interfaces are satisfied, the components stored in the asset repository 154 should interoperate with one another. Accordingly, the asset repository 154 can store software component written in different languages and having different forms of executables. Various software components in the asset repository 154 can be written in a platform independent manner, while others can be dependent upon one or more platforms. Additionally, different software components of the asset repository can conform to an object oriented architecture, a procedural architecture, a service oriented architecture (SOA), and the like.

It should be appreciated that the software components written at one level of granularity can be dependent upon the existence of one or more other software components written at a lower level of granularity. The lower level software component in this relationship can be considered a foundation software component and the higher level software component can be considered a composite software component. At some level, all software components can be considered dependent upon other software components, since software suites are dependent upon component software applications, which can be dependent upon a plurality of application tools, which can operate upon a specified operating system. Only those software groupings having a well defined set of interfaces can be considered individual software components for purposes of this patent.

To illustrate software components having dependencies, JAVA based software components can require that a target deployment platform implement a JAVA RUNTIME LIBRARY or a JAVA VIRTUAL MACHINE. Various Web service based software components can require that FLASH or .NET components be installed. Similarly, a software component can require the instantiation of a foundation class. Generally, prerequisites establish a hierarchy of software components that are built from one or more other, lower level software components.

Each software component of the asset repository 154 can be categorized into a granularity level. A system of granularity levels can be defined which forms a hierarchy of functional layers stacked one on top of the other. The granularity table 160 indicates one contemplated system of granularity levels. Abstraction of each software component at a designed granularity level can ensure that the software components of the asset repository 154 are able to be treated in a common fashion. Granularity level table 160 illustrates only one potential level-based categorization scheme for software components. Other categorization schemes for granularity level exist and can be accommodated by the inventive arrangements of system 100.

Levels included in table 160 comprise a kernel level 161, a graphical user interface (GUI) operating system (OS) level 162, a task level 163, a building block level 164, a system level 165, and an enterprise level 166. The kernel level 161 includes software component, such as low level disk access and mounting components, that permit an operating system to interface with hardware components. The GUI OS level 162 includes OS level software components, such as components that respond to mouse-click events. The task level 163 components are components that perform a well defined task, such as grammar checking or spell checking within an application. Task level 163 software components can be often be implemented as plug-in modules to existing applications. Building block level 164 software components can include software applications. System level 165 software components can each represent a suite of interoperable applications. Enterprise level 166 applications can include and end-to-end business solution.

It should be appreciated that in many cases, lines between different granularity levels can be somewhat arbitrary. For example, it is often different to determine if a Web program executing within a browser should be categorized as a task level 163 software component or a building block level 164 component. Similarly, it can be difficult to determine if a “suite” of related functions is properly categorized as a building block level 164 component or a system level 165 component. Often determinations for components are based upon the well defined interfaces of the software component and which other software components can be formed from or are interoperable with a particular software component.

The asset repository 154 can associate test assets from multiple types of testing, including functional testing, performance testing, and user acceptance testing, with related software components. Test assets can include testing scripts, testing drivers, testing data, testing objectives, testing scenarios, testing documents, and other testing artifacts and test tracking parameters. Test assets can include assets restricted to internal usage as well as assets shared with external entities.

The asset repository 154 can also associate deployment assets to software components. The deployment assets can include platform specific drivers, libraries, installation scripts, dependency mappings, and other artifacts for deploying a solution. In one embodiment, a deployment package can be automatically generated from information in the asset repository 154. In another embodiment, a deployment plan and one or more deployment tools can be generated using repository 154 information, which software technicians can utilize when deploying software.

The asset repository 154 can be a comprehensive tool for sharing and storing every aspect of an end-to-end software solution. For example, testing artifacts stored within the asset repository 154 can specify testing owners (possible internal usage restriction), testing contacts (internal), test environment architecture, components tested, operational models tested, business scenarios executed, interfaces tested, interactive diagrams tested, test tools utilized, test drivers utilized (internal), test problems reported (internal), problem prioritization (internal), deliverables, and testing timelines (internal). Deliverables can include whitepapers, redbooks, best practices, flash demonstrations, capacity guidelines, quick reference guides, installation instructions, and the like.

All of the assets of the asset repository 154 can be shared among software teams 122-125 and projects 142-146. Each project 142-146 can include multiple environments, such as a production environment 112, a performance test environment 114, and a functional test environment 116. Different types of tests can be performed by different teams 122-125 within the different environments 112-116. For example, team 122 and team 123 can both perform functional testing for project 142 within functional test environment 116. Team 124 can perform user acceptance testing in production environment 112. Team 125 can perform performance testing within performance environment 114. It is possible for multiple test teams 122-125 to simultaneously perform different types of tests for a common project 142.

In one embodiment, the asset repository 154 can be a remotely located repository similar in nature to a UDDI directory 150. That is, the asset repository 154 can be implemented as a generally accessible repository that conforms to an open standard that can be used by many different businesses, organizations, and teams.

In another embodiment, the asset repository 154 can be a distributed repository formed from a sharing of data among multiple local data stores 132-135. Each local data store 132-135 can store local asset information for a corresponding team, project, or environment. For example, team 122 can store asset repository information in data store 132. Restrictions can be imposed on the sharing of asset repository 154 information that occurs among the local data stores 132-135. Embodiments also exist where information is partially stored in a global repository 154 and is partially stored in local repositories 132-135.

As data within the asset repository 154 evolves, asset repository tools 156 can be provided that help manage and utilize the repository 154. For example, repository tools 156 can include search engines, Web-based development tools, configuration management tools, provisioning management tools, data mining engines, and the like.

The asset repository 154 can share information and software components with a plurality of other directories. For example, the asset repository 154 can share information relating to Web service components with UDDI directory 150.

Additionally, the asset repository can share information with one or more proprietary sources, such as component directory 152. Assuming software components in directory 152 are not directly stored in asset repository 154, asset repository 154 can still centrally manage test and deployment assets for the remotely located software components and provide additional value added services.

For example, component directory 152 can represent a directory of for-sale, proprietary software components. Each of these components can have a well defined interface and a designated level of granularity. Integration specialists can utilize multiple components of component directory 152 to construct an integrated solution. The asset repository 154 and tools 156 associated therewith can be used to construct the integrated solution, to automatically calculate and report a cost of component software components, and to facilitate the purchasing of needed components.

It should be appreciated that the arrangements shown in system 100 are for illustrative purposes only and that the invention is not limited in this regard. The functionality attributable to the various components can be combined or separated in different manners than those illustrated herein. Additionally, derivative and functionally similar implementations for the shown components are contemplated. For instance, in one embodiment, the UDDI directory 150, the component directory 152, and the asset repository 154, can be integrated into a single directory. In another contemplated embodiment, the asset repository 154 can be a master index to information stored in a plurality of local directories 132-135 and need not include assets and components within a dedicated storage space as described above.

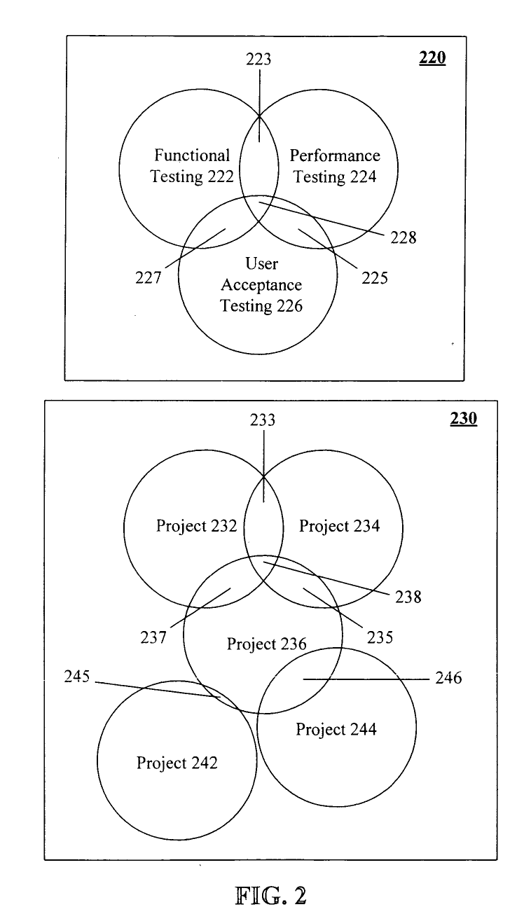

FIG. 2 includes two Venn diagrams that show a manner in which information of an asset repository can be shared in accordance with an embodiment of the inventive arrangements disclosed herein.

Diagram 220 shows that an asset repository can include assets for functional testing 222, performance testing 224, and user acceptance testing 226. Portions of each of the test assets of diagram 220 can be shared between different types of testing groups. Other portions of the assets can be unique for a particular type of testing. For example, functional testing 222 assets include some assets, such as functional testing objectives, which do not apply to other types of test assets.

Region 228 represents assets that are applicable to each type of testing, such as test drivers and test data sets for a software component. Region 227 represents a portion of test assets that can be shared between functional testing 222 teams and user acceptance testing teams 226, but not performance testing 224 teams, such as GUI appearance tests. Region 223 represents assets shared between functional testing 222 teams and performance testing 224 teams, but not user acceptance testing 226 teams. Region 225 represents assets shared between performance testing 224 teams and user acceptance testing 226 teams, but not functional testing 222 teams.

Additionally, different regions 222-228 can represent different default sharing permissions for asset types. For example, performance and user acceptance teams can be granted read/write permissions for assets in region 225, while functional testing teams may be restricted to read only permissions on those assets.

Diagram 230 shows that an asset repository can share assets among many different projects 232, 234, 236, 242, and 244. The various regions 233, 235, 237, 238, 245, and 246 of intersection can represent assets shared between the projects. The regions 233, 235, 237, 238, 245, and 246 of intersection can also represent different default share permissions.

It should be appreciated that default file share permissions can be explicitly altered by an asset controller, which will by default be a user who originally added an asset an asset repository. For example, an asset controller can override defaults and cause an asset in region 227 to be fully shared with performance testing 224 teams. Similarly, an asset controller of a project 242 asset can explicitly share the asset with project 234 teams.

In one embodiment, an asset repository tool can perform intelligent searches that inform different teams that potentially useful assets exist. If that team is not currently granted access to a desired asset, an asset share request can be sent to an asset controller, who can choose to grant or deny access to the requester. An asset share request can be incorporated into embodiments where asset controllers can charge others for assets stored in the asset repository. Consequently, requested assets can be provided to a requestor for a price established by the asset controller. Financial arrangements designed to benefit asset controllers can encourage asset sharing, asset repository usage, and asset reuse between different corporate entities.

It should be noted, that diagrams 220 and 230 can represent an information sharing scheme established between multiple different data stores, each functioning as a localized data repository that selectively shares data with other data stores. In one embodiment, the shared regions can represent a set of data that is synchronized between different data stores. For example, a data store for functional testing 222 assets and a data store for user acceptance testing 226 assets can be synchronized to share data of region 227.

In another embodiment, each distinct region of Venn diagrams 220 and 230 can represent separate data storage areas. For example, region 228 can represent a centralized data storage space accessible by all testing teams. Similar teams working on project 234 can have access to four different data stores containing shared assets, one associated with project 234, another associated with region 233 data only, yet another associated with region 238, and still another associated with region 235.

Each data store or repository discussed in FIG. 1 and FIG. 2 can be a physical or virtual storage space configured to store digital information. Each data store can be physically implemented within any type of hardware including, but not limited to, a magnetic disk, an optical disk, a semiconductor memory, a digitally encoded plastic memory, a holographic memory, or any other recording medium. Each data store can be a stand-alone storage unit as well as a storage unit formed from multiple physical devices. Additionally, information can be stored within each data store in a variety of manners. For example, information can be stored within a database structure or can be stored within one or more files of a file storage system, where each file may or may not be indexed for information searching purposes. Further, each data store can utilize one or more encryption mechanisms to protect stored information from unauthorized access.

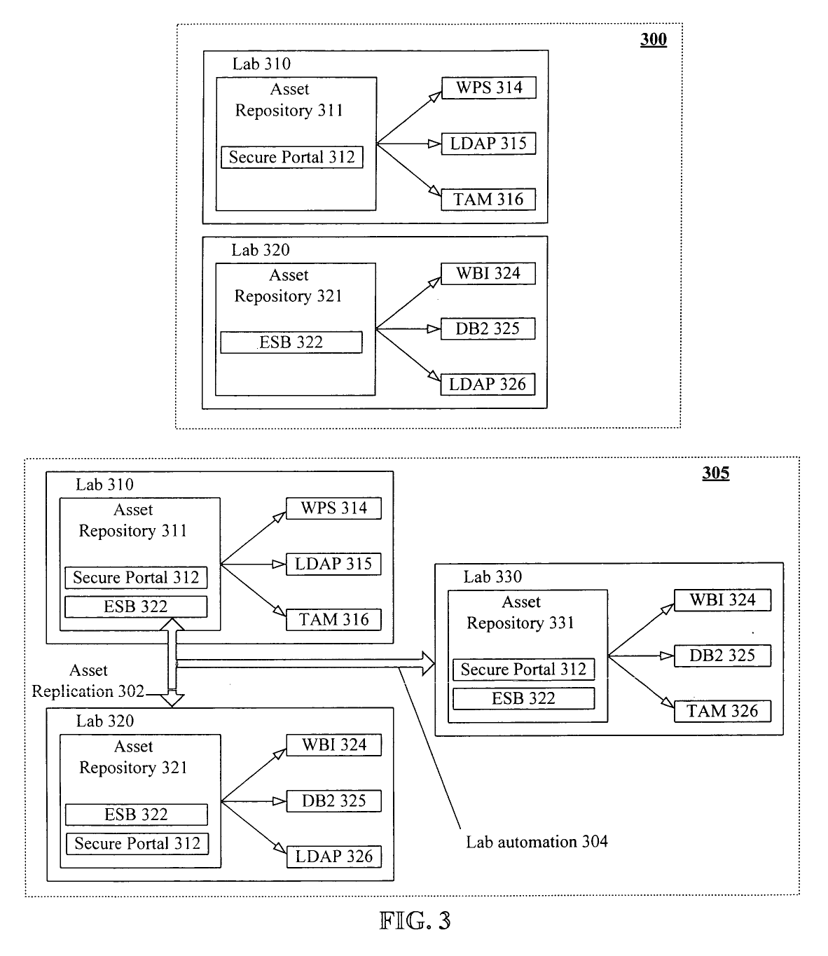

FIG. 3 is a schematic diagram illustrating the sharing of assets between multiple labs in accordance with an embodiment of the inventive arrangements disclosed herein. Each lab can represent a software development graphical user interface that is linked to asset repositories 311 and 321. Each of the labs 310, 320, and 330 can coordinate efforts of different business entities or business divisions that are cooperating on software projects. For example, a testing organization, a software development company, a business partner, a support center, contact software developers, Web service provides, and beta testers can each access, develop, and utilize the software components, test assets, and implementation assets of the labs.

Using the GUI, one or more lab projects can be constructed from a plurality of software components. The results of each lab 310, 320, and 330 can be a software solution that can be stored within the asset repository as a software component having a granularity level one higher than the foundation software components used in its construction.

The software assets stored in the asset repository can each be associated with testing and deployment assets. In one embodiment, existing software solutions, such as TIVOLI Configuration Manager and TIVOLI Provisioning Manager can be utilized to automate the installation/configuration/customization of software components used in the labs. Accordingly, automated solutions can be developed directly from asset repository 311, 321, and/or 331. Consequently, each asset repository 311, 321, and/or 331 can be used to create a consistent and standard set of installation, configuration, and customization solutions that are able to be shared among multiple repositories upon once validated. As more users produce more software projects using software development tools compatible with those of lab 310, 320, 330, the overall quantity and value shared among different asset repositories grows. This growth of asset repository data can continuously increase software development, testing, and deployment efficiency and effectiveness.

In diagram 300, lab 310 can be responsible for creating a secure portal 312 software component that contains information for the installation, configuration, and testing of a secure portable building block 312. To create building block 312 multiple foundation components, such as a portal, a directory, and security information should be combined. These components are represented by WEBSPHERE Portal Server (WPS) 314, Lightweight Directory Access Protocol (LDAP) 315, and TRIVOLI Access Manager (TAM) 316, respectively.

Lab 320 can be responsible for the creation of an enterprise service bus software component that contains information for the installation, configuration, and testing of an enterprise service bus building block 322. To create building block 322, middleware, database, and directory information foundation components can be combined. These components are represented by WEBSPHERE Business Integration (WBI) 324, DB2 325, and LDAP 326, respectively.

Once building blocks 312 and 322 have been created, tested, and declared ready for distribution, they can be shared in an automated fashion with a plurality of other labs via by sharing asset repository information between labs. For example, as shown in diagram 305, labs 310 and 320 can configure an asset replication 302 process to share information between local asset repository 311 and local asset repository 321. Thus, lab 310 can obtain the enterprise service bus building block 322 from asset repository 321 and lab 320 can obtain secure portal building block 312 from asset repository 311.

It should be noted that each lab acquires all previous test assets and deployment assets for the shared building block, when the building block is obtained. If additional testing is performed, if additional documentation is created for the building block, and/or if additional deployment configurations implemented for an obtained building block, those additional assets can be stored in a local asset repository and can be associated with the building block. These new assets can be automatically shared among labs 310 and 320 via asset replication process 302.

Additionally, lab 330 can reuse the secure portal building block 312 and enterprise service bus building block 322 that have already been developed, tested, and implemented by lab 310 and lab 320. A lab automation process 304 can be established to permit building blocks 312 and 322 to be replicated from either repository 311 or repository 321 and placed in repository 331. When lab 330 adds additional assets to the asset repository 331 for building blocks 312 and 322, these assets can be automatically shared with lab 310 and lab 320. In one embodiment, lab 330 can be an integration lab that takes responsibility for integration issues between building block 312 and building block 322.

In one embodiment, each of the labs 310, 320, and 330 can be designated as an administrator. The building block administrator can have final authority relating to a building block or block aggregation. For example, a building block administrator can maintain version control, test responsibility, upgrade responsibility, compatibility responsibility, and the like. In one embodiment, a building block administrator can receive financial rewards from users of the building blocks that are being administrated.

By default, the building block administrator can be the building block creator. For example, lab 310 can be the administrator for block 312, lab 320 can be the administrator for block 322, and lab 330 can be an aggregation administrator for the integrated aggregate of building blocks 312 and/or 322. Lab 330 as the aggregation administrator can be responsible for analyzing which versions of the aggregated building blocks interoperate.

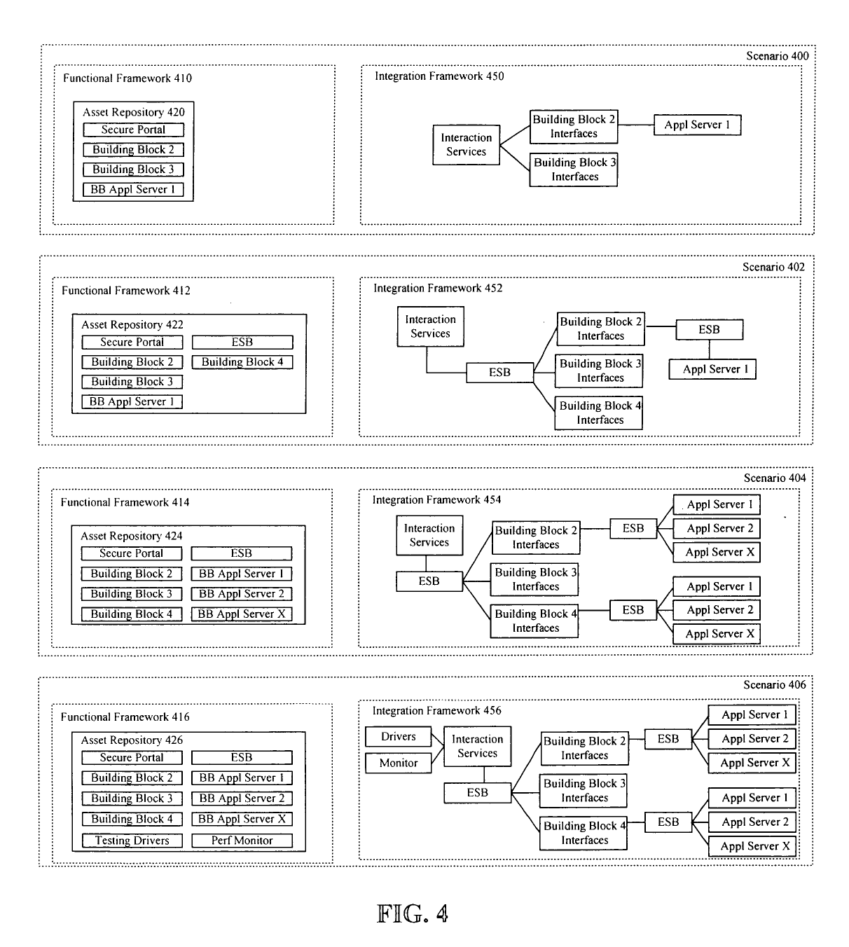

FIG. 4 is a schematic diagram illustrating how the reusable assets in the shared repository can evolve with usage. This evolution occurs in a gradual and flexible manner. As new technologies and software design approaches are developed, the repository can quickly adapt to accommodate software components, test assets, and implementation assets that are based upon the new technologies. For example, new functions, testing models, and integration requirements for SOA technologies can be integrated with object oriented technologies in a seamless fashion. Moreover, new development models, libraries, tools, and the like can be selectively integrated on a project-by-project, lab-by-lab, user-by-user, and/or component-by-component basis thereby permitting smooth and relatively painless migrations from legacy software systems. Additional assets, such as training assets and customer support assets, can also evolve using the shared repository disclosed herein.

FIG. 4 includes temporally sequential scenarios 400-408, which illustrate the evolution of an asset repository 420-426. In scenario 400, a functional and/or development framework 410 can include asset repository 420 that includes several packages of software components, shown at the building block level. These building block level software components include a secure portal, building block 2, building block 3, and building block application server 1. Framework 410 can be used to provision all appropriate software components to designated hardware to automatically (or with some level of manual/automation interaction) create integration testing framework 450, which can be used by test teams. Framework 450 illustrates that interaction services can be connected to building block 2 and building block 3. Building block 2 can be connected to application server 1.

One value of integration testing framework 450 is that it permits testing personnel to test a solution (at the system level) while abstracting software details that occur at granularity levels beneath the building block level. Instead, testers using framework 450 can focus upon functional, performance, and/or user requirements depending upon the type of testing being conducted. It should be appreciated that the framework of FIG. 4 can be configured for any granularity level and is not limited to system level testing of solutions composed of building block level software components. For example, the illustrated framework can be used to conduct enterprise level testing of solutions composed of system level software components.

Scenario 402 is an evolution of scenario 400, where an enterprise service bus building block and building block 4 have been added to the asset repository 422 of functional framework 412. It should be appreciated that one or more of these added building blocks can be pre-existing building blocks acquired from other asset repositories. For example, the enterprise service bus building block can be automatically acquired from another lab's repository, as shown in FIG. 3.

Additional components for pre-existing building blocks can also be added. For example, support for a new data model can be added to building block 2. Further, macro level definitions can for the acquired enterprise service bus building block can be added. Micro level building block definitions for communicating with application server via the enterprise service bus component can be added to building block 2. All appropriate software components of the function framework 412 and all applicable integration and testing components from framework 450 can be combined to generate integration framework 452.

Framework 452 shows that interaction services can be connected to the enterprise service bus. The enterprise service bus can be connected to building blocks 2-4. Building block 2 can be connected to the enterprise service bus. The enterprise service bus can be connected to application server 1.

Scenario 404 is an evolution of scenario 402. In functional framework 414, building block 4, application server 2, and application server X can be added. Micro level service bus definitions can be added to building block 4 for the enterprise service bus communications with application servers. New functionality can be added to the enterprise service bus in functional framework 414. Integration testing framework 454 can be generated from functional framework 414.

Framework 454 shows that interaction services can be connected to the enterprise service bus, which connects to building blocks 2-4. Building blocks 2 and 3 can connect to the enterprise service bus, which connects to application servers 1, 2, and X.

Scenario 406 is an evolution of scenario 404. In functional framework 416, a testing driver building block and a performance monitor building block can be added to asset repository 426. Framework 416 can be used to generate integration testing framework 456. In framework 456, drivers and performance monitor components can be linked to the interaction services as illustrated.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for sharing reusable software development assets comprising:
componentizing a plurality of software components, each software component having a set of well defined interfaces;
cataloging the plurality of software components within different granularity levels, said granularity levels including a building block level and a system level, wherein at least a portion of the software components of the system level are formed using a plurality of software components of the building block level;
identifying a plurality of test assets, each test asset being associated with at least one of the software components, wherein the test assets include assets for functional testing, user acceptance testing, and performance testing; and
storing said software components and said test assets in a searchable asset repository, wherein the asset repository is accessible by a plurality of test teams, wherein the plurality of teams include teams performing different types of testing, wherein the different types of testing include functional testing, user acceptance testing, and performance testing, whereby functional test teams, user acceptance test teams, and performance test teams are able to access test assets of other teams performing tests upon related software components.

2. The method of claim 1, wherein the test assets include testing scripts, testing drivers, and testing data.

3. The method of claim 1, wherein the test assets include testing objectives, testing scenarios, and testing documentation.

4. The method of claim 1, further comprising:
providing a development interface configured to permit the creation and manipulation of a plurality of labs, wherein each lab permits user to graphically utilize assets of the asset repository for a specific software project.

5. The method of claim 4, wherein the asset repository is one of a plurality of asset repositories, each asset repository automatically sharing data relating to software components and test assets with other asset repositories, wherein different labs are associated with different asset repositories.

6. The method of claim 4, further comprising:
automatically populating a new one of the labs with previously stored software assets and test assets from at least one other lab.

7. The method of claim 4, wherein a plurality of labs utilize a same software component, said method further comprising:
presenting a change notification within other ones of the labs whenever one of the labs changes a stored asset associated with the same software component.

8. The method of claim 1, wherein the software components comprise Web services.

9. The method of claim 1, wherein said steps of claim 1 are performed by at least one machine in accordance with at least one computer program having a plurality of code sections that are executable by the at least one machine.

10. A software development graphical user interface comprising:
a user configurable lab, wherein the lab includes a plurality of graphical objects representing software components, wherein each software component is a componentized software unit having a set of well defined interfaces, and wherein each software component is categorized into one of a plurality of granularity level, said granularity levels including a building block level, a system level, and a solution level, and wherein each software component is associated with a plurality of test assets;
a functional development view of the lab that includes a plurality of graphical objects for functional test assets associated with the software components established for the lab; and
an integration testing view of the lab automatically generated at least in part using previously stored functional test assets and software components specified in the functional development view.

11. A method used for developing software comprising:
storing a plurality of assets within a shared asset repository, said assets comprising software components and test assets associated with the software components;
categorizing said assets by granularity level, wherein the stored software components comprise foundation software components and composite software components, wherein each composite software component comprises a plurality of foundation software components having a granularity level one lower than the composite software component;
identifying criteria for a new software component;
automatically determining at least one stored composite software component having similar criteria as the identified criteria by searching the shared asset repository, wherein the composite software component is categorized at the same level of granularity as the new software component;
utilizing a development interface to construct the new software component from a plurality of foundation software components associated with the at least one composite software components; and
testing the new software component utilizing at least one test asset previously stored within the shared asset repository that is associated with a software component selected from a group consisting of the foundation software components upon which the new software component was constructed and the automatically determined composite software component.

12. The method of claim 11, wherein said assets further comprise deployment assets associated with the software components, said method further comprising:
deploying the new software component utilizing at least one deployment asset previously stored within the shared asset repository that is associated with a software component selected from a group consisting of the foundation software components upon which the new software component was constructed and the automatically determined composite software component.

13. The method of claim 11, wherein said assets further comprise integration assets associated with the determined composite software component used to integrate at least two foundation software components to the composite software component, said method further comprising:
integrating the plurality of software components to the new software component using at least one of the integration assets.

14. The method of claim 11, wherein utilizing step further comprises:
presenting a lab interface for developing the new software component, said lab interface providing an automatically generated template for the new software component comprising the foundation software components, wherein the lab interface permits the template to be customized and thereafter stored for the new software component.

15. The method of claim 11, wherein the granularity levels of the categorizing step comprise at least three sequentially order levels, including an upper level, a middle level, and a lower level, wherein at least one upper level software component is formed from at least one middle level software component that is formed form at least one lower level software component, wherein each of the upper level software component, middle level software component, and lower level software component are software components stored in the asset repository, and wherein each is associated with at least one test asset stored in the asset repository.

16. The method of claim 15, wherein the upper level is a solution level, wherein the middle level is a system level, and wherein the lower level is a building block level.

17. The method of claim 11, said method further comprising:
storing the new software component in the shared asset repository; and
granting other users access to the new software component so that the determining step for at least one of the other users of the method returns the new software component as the automatically determined composite software component.

18. The method of claim 11, wherein the test assets include assets for functional testing, performance testing, and user acceptance testing, which are shared among different testing teams that perform testing against a stored software component associated with the test assets.

19. The method of claim 11, wherein the software components comprise Web services.

20. The method of claim 11, wherein said steps of claim 11 are performed by at least one machine in accordance with at least one computer program having a plurality of code sections that are executable by the at least one machine.
